(19) United States
(12) Patent Application Publication
(10) Pub. No.: US 2012/0100097 A1
(43) Pub. Date: Apr. 26, 2012

(54) CELLULOSE SUPPORT CONTAINING D-MANNOSE DERIVATIVES

(76) Inventors: Menno Dufour, Lyon (FR); Lynda Ferez, Provins (FR)

(21) Appl. No.: 13/318,280

(22) PCT Filed: Apr. 23, 2010
(86) PCT No.: PCT/FI2010/050337

§ 371 Date: Jan. 12, 2012

(30) Foreign Application Priority Data
Apr. 30, 2009 (FR) 0952932

(51) Int. Cl. A01N 43/16; A01P 1/00; C08F 8/00

(52) U.S. Cl. 424/78.18; 525/54.23

(57) ABSTRACT

Cellulose support containing mannose derivatives able to fix type 1 piliated bacteria, application to disinfecting wipes especially. Support intended to bind type 1 piliated bacteria comprising cellulose fibers and/or regenerated cellulose fibers onto which mannose derivative is fixed characterized in that the mannose derivative is present in the form of copolymer obtained by copolymerization of: —a monomer derivative of alkenyl α-D-mannopyranoside modified with a function capable of reacting with an acrylamid monomer, —a cationic monomer —an acrylamid monomer.

The object of the invention is a cellulose support the surface of which is treated with mannose derivatives capable of binding type 1 piliated bacteria. A further object of the invention is a novel disinfecting wipe concept implementing said support.

In the rest of the description the invention is described in greater detail in application of wipes with disinfecting abilities particularly in view of the type 1 piliated Escherichia coli bacteria. These bacteria are present particularly in infections of the urinary tract of women mostly. Naturally all bacteria such as Salmonella, Shigella, Kleblsiella, Enterobacteria and Proteus having type 1 pili on their surface also constitute possible targets for wipes of the invention and, more generally, any support treated with mannose derivative according to the invention.

It is now established that the glycoconjugates ending with a mannose motif present on cell surfaces in the urogenital tract constitute major binding areas for type 1 piliated Escherichia coli bacteria.

Based on this observation it has been suggested to incorporate mannose derivative polymers in wipes in order to obtain disinfecting qualities. Thus for example document U.S. Pat. No. 5,718,909 describes non woven supports containing a copolymer obtained by copolymerization of 4-acryloylamido-phenyl alpha D-Mannopyranoside with acrylamide. In practice the copolymer is mixed with fibers prior to formation and at high temperature. This solution has at least two major drawbacks.

Firstly, 4-acryloylamido-phenyl alpha D-Mannopyranoside requires a high number of synthesis stages. Additionally, fixation of mannose derivatives on fibres does not seem optimal because leaching out of the copolymer can be observed, which makes the disinfecting effect of the support inefficient.

In other words the invention aims to find a solution to the problem by developing a cellulose support, a cellulose wipe in particular, treated with mannose derivatives by using a similar principle as suggested by prior art without said drawbacks, in other words especially the difficulty encountered with synthesis of sugar derivatives and enhancement of their fixation to the surface of the support.

Therefore the Applicant has focused his study on one hand on the very nature of the mannose derivatives, and on the other hand on the fixation of said derivatives on the cellulose fibers.

With this approach the Applicant has noticed that the binding capacity of mannose alkenyl derivatives, particularly of allyl-α-D-Mannopyranoside, to type 1-piliated Escherichia coli bacteria is remarkably advantageous in comparison with the other mannose derivatives, particularly the saturated alkyl derivatives.

Additionally, the Applicant has also noticed that the copolymerization of the mannose derivative in the form of an akrylamide based terpolymer, one monomer of which is formed of an cationic monomer, allowed the derivative to attach efficiently onto the cellulose while maintaining the binding activity of sugar to Escherichia coli. In fact the presence of cationic monomers and acrylamide monomers generated the formation of ionic bonds with cellulose thereby reinforcing the binding phenomen.

In the following it will become evident that the immobilization of the mannose derivative on the cellulose support allows sugar to compete with mannose molecules residing on the surface of cells in the urogenital tractus thanks to its outstanding capability to bind type 1 piliated Escherichia coli bacteria.

In other words the object of the invention is a woven or a non woven support able to bind type 1 piliated bacteria comprising cellulose fibers or regenerated cellulose fibers onto which a mannose derivative is attached. The support is characterized in that the mannose derivative is present in the form of a terpolymer obtained by copolymerization of:
a monomer derivative of modified alkenyl-α-D-mannopyranoside with a function able to react with an acrylamid monomer, particularly an acrylamid, acrylic, vinylic, maleic, fumaric or allyl function,
a cationic monomer
an acrylamid monomer.

The results obtained by the Applicant have been particularly favorable when the monomer derivative of alkenyl-α-D-Mannopyranoside is a monomer derivative of allyl-α-D-mannopyranoside having the following formula:

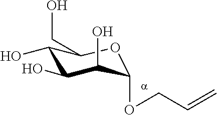

In addition, and in accordance with the invention, the monomer derivative of allyl-α-D-Mannopyranoside is advantageously a monomer derivative of 3-(2-aminoethylthio)propyl α-D-mannopyranoside having the following formula:

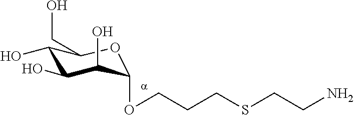

It follows that the 3-(2-aminoethylthio)propyl α-D-mannopyranoside modified with a function capable of reacting with a acrylamid monomer, in practice an acrylamid function, is a monomer having the following formula:

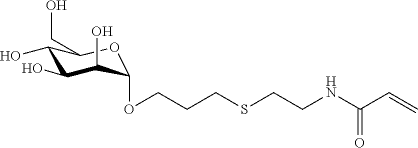

When cationic monomer is in question any known cationic monomer may be used such as the vinylic monomers and, more precisely, the 2-(trimethylammoniumchloride)ethyl methacrylate (TMAEM).

According to another characteristic the terpolymer contains:
between 0.25 and 20 mol % of monomer derivative of alkenyl α-D-mannopyranoside modified with a function capable of reacting with an acrylamid monomer,
between 70 and 90 mol % of acrylamide
between 5 and 20 mol % of cationic monomer.

In a preferred embodiment the terpolymer of the invention has the following formula:

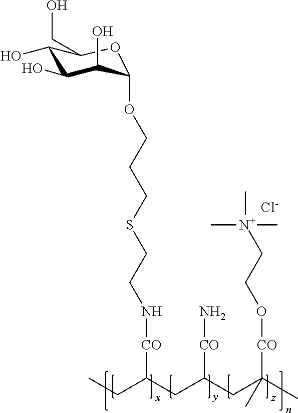

with
0.025<x<2
7<y<10
0.5<z<2
10<n<10000

According to another characteristic the support according to the invention contains advantageously at least 10⁻⁵/m² of D mannose. Below this value the obtained disinfecting effect is limited.

The support in its turn contains, as already mentioned, cellulose fibers or regenerated cellulose fibers, in the latter case, viscose. Nevertheless, the support may also contain synthetic fibers such as for example polyester, polypropylene, polyamide, polyacrylic, polyvinylic alcool, polyethylene fibers alone or mixed. It can be a woven or non woven support.

The support may be used as humid or dry wipe for the disinfection of the periuretral tract of women in particular, but also as a disinfecting wipe in any other application such as, for example, wiping hands or even inert surfaces, such as for example refrigerators.

The manufacturing processes of wipes are well know to the man skilled in the art and it is not necessary to describe them more in detail in this application.

Thanks to its solubility in water it is possible to apply the copolymer onto the surface of the cellulose support by size press.

In other words another object of the invention is a treatment method for cellulose support described earlier consisting of, after sheet formation, applying the polymer onto the sheet surface by size press.

Yet another object is a method of disinfecting an inert or living surface colonized by type 1 piliated bacteria consisting of bringing in contact said bacteria with an allyl-α-D-mannopyranoside constituted substrate. According to the method the substrate is modified chemically in order to be copolymerized attaching ionically the terpolymer described earlier to a cellulose support.

The invention and its advantages are clearly presented in the following examples supported by the figures in annex.

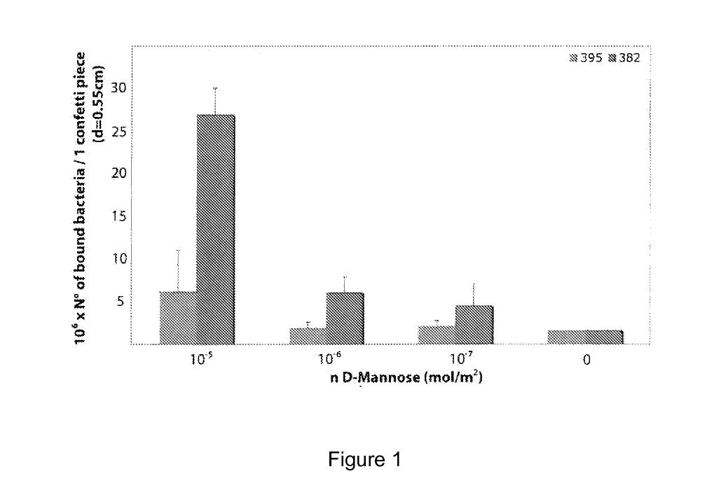

The sole FIG. 1 is a graph that represents the binding capacity of allyl-α-D-Mannopyranoside derivative terpolymer to Escheria coli when said polymer is applied on a wipe.

### I/Bacteriological Efficiency of Allyl-α-D-Mannopyranoside

In this part the bacteriological efficiency of various mannose derivatives, before copolymerization and incorporation in the cellulose support, is tested.

The tested molecules are the following:

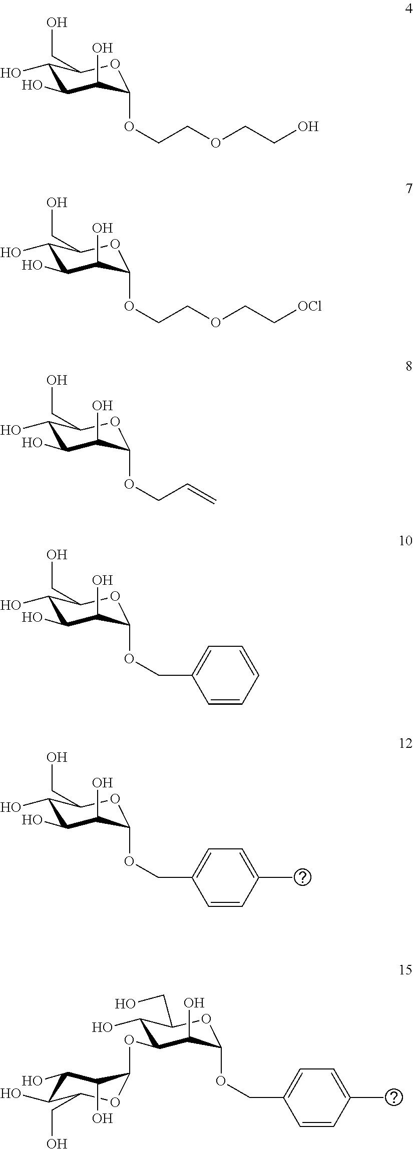

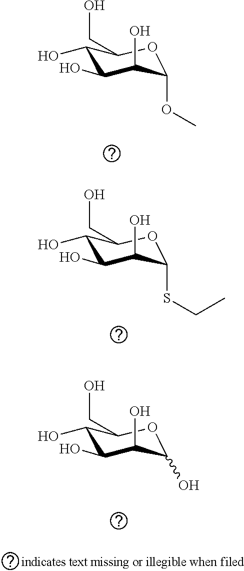

(4): 2-[(2-hydroxy-)ethoxy-]-ethyl α-D-Mannopyranoside
(7): 2-[(2-methoxy-)ethoxy-]-ethyl α-D-Mannopyranoside

### (10): Benzyl-α-D-Mannopyranoside

(12): p-Aminophenyl-α-D-Mannopyranoside
(15): p-Nitrophenyl 3-O-α-D-Mannopyranosyl-α-DMannopyranoside

### (8): Allyl-α-D-mannopyranoside

1. Test Protocol

The conducted bacteriological test is an agglutination yeast test. In fact the bacteria Escherichia coli with type 1 pili, have the capacity to agglutinate yeasts. The agglutination may be prevented by mannose derivatives. The strain 382 of Escherichia coli obtained from National Bacteriological Laboratory of Stockholm, which expresses in a stable manner type 1 pili, is used. The expression of the pili can be enhanced by growing bacteria by way of three subcultures in a nutrient broth (NB, oxiod). After culture the bacteria are centrifuged and added as suspension in the same amount of phosphate buffered saline (PBS pH 7.2). A concentration of bacteria equal to 2-3.10⁹ bacteria/ml is obtained. Baker's yeasts are added as suspension into PBS at a final concentration of 5.10⁸ cells/ml. The various mannose derivatives are diluted from the initial concentration of 20 mg/ml maximum in two stages in PBS. Into 50 μl of each diluted sugar 50 μl of Escherichia coli is added and incubated at room temperature for 15 min to allow interaction. Finally 50 μl of yeast is added into each tube. After another 15 min. incubation at room temperature and one night at 4° C., agglutination, in other words interaction between bacteria and yeast, is evaluated.

2. Results

The result are presented in the table below:

| | Inhibitive |
|---|---|
| Compounds | activity in % |
| D-Mannose | 100 |
| Methyl-α-D-Mannoside | 45 |
| 2-[(2-hydroxy-)ethoxy]-ethyl α-D-Mannopyranoside (4) | 24 |
| 2-[(2-methoxy-)ethoxy]-ethyl α-D-Mannopyranoside (7) | 24 |
| Benzyl-α-D-Mannopyranoside (10) | 24 |
| Ethyl 1-thio-α-D-mannopyranoside | 18 |
| p-Aminophenyl-α-D-Mannopyranoside (12) | 0.93 |
| p-Nitrophenyl 3 O-α-D-Mannopyranosyl-α-D- | 0.70 |
| Mannopyranoside (15) | |
| Allyl α-D-Mannopyranoside (8) | 0.12 |

Inhibitive activity is obtained by dividing the minimum inhibitive concentration (in mg/ml) of each product by the inhibitive concentration of the reference product: D-mannose, multiplied by 100.

These results show on one hand the importance of the presence of a hydrophobe aglycone part in view of a hydrophile aglycone part (products 4 and 7 against product 8). It is also observed that the alkenyl-α-D-Mannopyranosides, particularly the allyl α-D-Mannopyranoside, has an exceptionally strong affinity.

II/Disinfecting Capacity of a Support Treated with Allyl α-D-Mannopyranoside Derivative

In this part the disinfecting effect of a support treated with a allyl α-D-Mannopyranoside derivative copolymer is demonstrated.

1. Allyl α-D-mannopyranoside synthesis

The mannose derivative is synthetized according to the reaction scheme followed by Fischer glycolysation of 1,2,3,4,6-penta-O-acetyl α-D-mannopyranoside in the presence of allyl alcohol, then acetyl functions are unprotected.

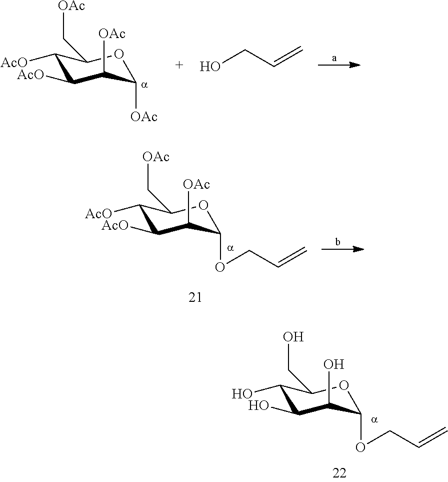

An amount 4.9 g of 1,2,3,4,6-penta-O-acetyl α-D-Mannopyranoside is dissolved in anhydr DCM. under nitrogen atmosphere. 3.43 ml of allyl alcohol is added followed by adding 7.91 ml of boron trifluoride diethyl etherate in drops. The mixture is strirred under nitrogen at room temperature during 5 h and heated at 40° C. over night. The mixture is then saturated with NaHCO₃ solution. The solution is then diluted in a same volume of DCM again. Allyl 2,3,4,6 tetra-O-acetyl-α-D-mannopyranoside is obtained and purified by column chromatography. Allyl 2,3,4,6 tetra-O-acetyl-α-D-mannopyranoside is dissolved in 50 ml of methanol. Then 1 ml of methanolic sodium methoxide solution is added. After 3 hours amberlite resin is added to neutralize and the solution is filtrated, then concentrated.

2. Synthesis of 3-(2-aminoethylthio)propyl α-D-Mannopyranoside from α-D-mannopyranoside

The reaction consists of elongation of alkyne group of allyl α-D-Manopyranoside by adding 2-aminoethanethiol according to the following reaction scheme:

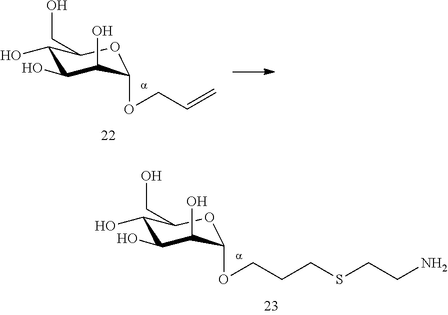

1,2153 g of allyl α-D-mannopyranoside is dissolved in water in presence of 570 mg of cysteamine hydrochloride. The solution is then irradiated under UV during 17 hours. The solution is lyophilized and the oil residues are purified by silica gel chromatography by using methanol as diluent.

3. Syntesis of 3-(2-aminoethylthio)propyl α-D-Mannopyranoside modified with an acrylamide function

The principle of the reaction is a conversion of 3-(2-amonoethylthio)propyl α-D-mannopyranoside into glycosidic acrylamide according to the following reaction scheme:

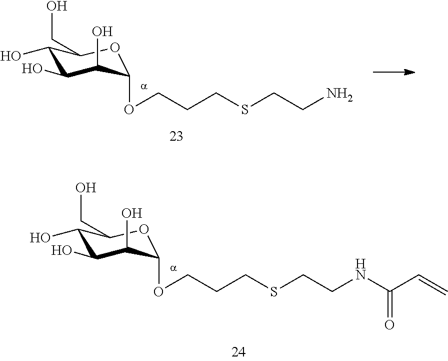

1 g of 3-(2-aminoethylthio)propyl α-D-Mannopyranoside is solubilized in 15 ml of water/ethanol (relation 1/1) mixture in presence of 1.54 g of sodium carbonate. The mixture is then cooled at 0° C. under agitation and then 1,546 ml of acryloyl solution is added in 7 ml of tetrahydrofuran during 5 min. in drops. The reaction is followed by TLC (chloroforme-methanol). After 1 hour of reaction the solution is filtered and concentrated.

The product is purified by successive chromatography.

4. Synthesis of terpolymer comprising acrylamide 3-(2-aminoethylthio)propyl α-D-Mannopyranoside monomer, cationic 2-(trimethyl ammoniumchloride)ethyl methacrylate (TMAEM) monomer and acrylamide monomer.

The terpolymer is obtained by free radical terpolymerization of said three monomers in a molar ratio of 10/10/80. For reminder, the terpolymer obtained has the following formula:

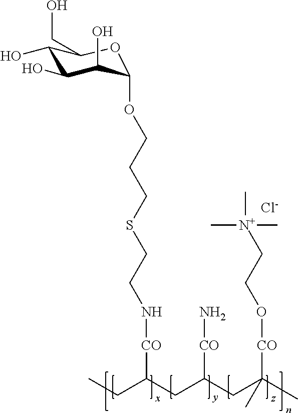

In the terpolymerization reaction 12.5% by weight of monomer in said ratio and 3% by weight of azobis(isobutyronitrile) (AIBN) is used. More specifically 613 mg of 3-(2-acryloylaminoethylthio)propyl α-D Mannopyranoside, 359 mg of TMAEM, 992 mg of acrylamide and 60 mg of AIBN is dissolved in 17.5 ml of ethanol at 0° C. The mixture is then polymerized under agitation at 50° C. during 19 hours under nitrogen. The solution is then concentrated to 2 ml and the polymer is precipitated in 100 ml of a mixture of cold acetone/ether (1/1, volume/volume), filtered and dried with air.

5. Support Treatment

### 5.1 Treatment with Copolymer

The support used is a non woven of 45 g/m² composed of 100% lyocell fibers originating from wood pulp cellulose.

Three different concentrations of mannose derivative are applied. Indicated in mole of D-mannose, the three concentrations are the following:
10⁻⁷ mol/m²
10⁻⁶ mol/m2
10⁻⁵ mol/m2

The support samples are submitted to a treatment by size press, commercial make MATHIS®, at a speed of 4.7 min. at a pressure of 2 bars. The samples are collected and weighed immediately. The samples are then dried on a drying plate (drying by contact) at 110° C. during some minutes.

### 5.2 Bacteriological Efficiency of Treated Supports

According to the conducted protocol two bacteria strains of Escherichia coli 395 (which express little or none type 1 pili) and Escherichia coli 382 (which expresses strongly type 1 pili) are incubated in 5 ml of standard nutritional media (LB-BROTH) and 20μ of tritiated thymidine during 2 hours at 36° C. The bacteria are then replaced as suspension in the same volume of PBS. Some pieces are cut from the samples of treated supports. 200μ of bacteria as suspension is applied on each piece and incubated at 36° C. during 20 minutes. The pieces are then washed in PBS and the radioactivity is measured. The results are indicated in CPM and then converted into number of immobilized bacteria, bearing in mind that 1 CPM corresponds to approximately 20 000 bacteria. The support cuts are of the size of 0.55 cm.

### 5.3 Results

Most importantly bacteriological efficiency of terpolymer is tested by agglutination test directly on the strains of Escherichia coli. The results are presented in the table below:

| Compound | Inhibitative activity |
|---|---|
| D mannose | 100 |
| Terpolymer | 0.48% |

These results show a strong affinity of terpolymer contrary to Escherichia coli bacteria. Such level of activity is comparable to the one obtained with allyl α-D-mannoside, as illustrated earlier, when used as such.

The bacteriological results obtained after treatment of supports with terpolymer are indicated in FIG. 1. It can be seen that the higher the mannoside density rises the stronger the binding of bacteria Escherichia coli 382 is. Nevertheless, these results show clearly the specific bond of the type 1 piliated bacteria with sugar in comparison with negative witness represented by strain Escherichia coli 395 expressing weakly type 1 pili.

The invention and the advantages deriving from it are clearly represented in the specification. Particularly noteworthy is the disinfecting efficiency of alkenyl α-D-Mannopyranosides, in particular of allyl α-D-mannopyranoside, especially obvious in view the type 1 piliated bacteria. On the other hand it is stressed that this efficiency remains virtually unchanged when the sugar derivative is synthetized in the form of a cationic terpolymer permitting in addition securing the optimal fixation of sugar on the cellulose support by ionic bonds.

1. Support intended to bind type 1 piliated bacteria, comprising cellulose fibers and/or regenerated cellulose fibers onto which mannose derivative is attached, characterized in that the mannose derivative is present in the form of a terpolymer obtained by copolymerization of:
a monomer derivative of alkenyl α-D-mannopyranoside modified with a function capable of reacting with an acrylamid monomer,
a cationic monomer
an acrylamid monomer

2. Support according to claim 1 characterized in that the monomer derivative of alkenyl α-D-mannopyranoside is a monomer derivative of allyl-α-D-mannopyranoside.

3. Support according to claim 2 characterized in that the monomer derivative of allyl-α-D-Mannopyranoside is a monomer derivative of 3-(2-aminoethylthio)propyl α-D-mannopyranoside having the following formula:

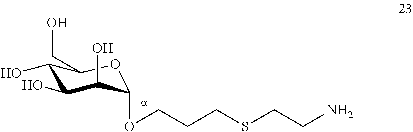

4. Support according to claim 3 characterized in that the monomer derivative of 3-(2-aminoethylthio)propyl α-D-mannopyranoside is modified with an acrylamide function having the following formula:

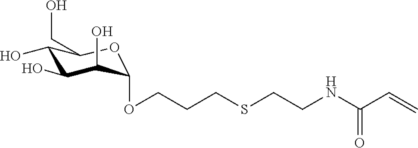

5. Support according to claim 1 characterized in that the cationic monomer is the 2-(trimethylammoniumchloride)ethyl methacrylate (TMAEM).

6. Support according to claim 1 characterized in that copolymer has the following formula: or 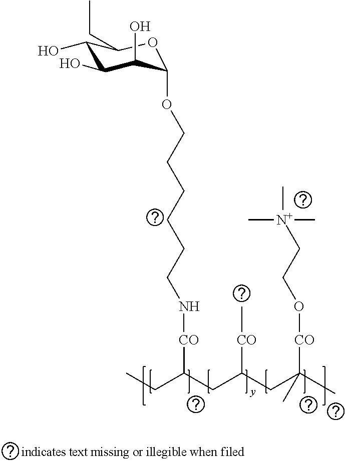
with
0.025<x<2
7<y<10
0.5<z<2
10<n<10000

7. Support according to claim 1 characterized in that the terpolymer contains:
between 0.25 and 20 mol % of monomer derivative of alkenyl α-D-mannopyranoside modified with a function capable of reacting with an acrylamid monomer,
between 70 and 90 mol % of acrylamid
between 5 and 20 mol % of cationic monomer.

8. Support according to claim 1 characterized in that it contains at least 10⁵ mol/m² of D mannose.

9. Support according claim 1 characterized in that it contains among others synthetic fibers selected from a group comprising polyester, polypropylene, polyamide, polyacrylic, polyvinylic alcool, polyethylene fibres alone or mixed.

10. Use of support object of claim 1 as a wipe.

11. Treatment method of the support object of claim 1 consisting of after sheet formation of applying the polymer on the sheet surface by size press.

12. Disinfecting method for an inert or living surface colonized by type 1 piliated bacteria consisting of bringing in contact said bacteria with a allyl-α-D-mannopyranoside constituted substrate.
